(19) United States
(12) Patent Application Publication
(10) Pub. No.: US 2020/0369248 A1
(43) Pub. Date: Nov. 26, 2020

(54) METHOD FOR CONTROLLING A HYDRAULIC BRAKE SYSTEM DURING A REGENERATIVE BRAKING PROCESS, HYDRAULIC BRAKE SYSTEM, COMPUTER PROGRAM PRODUCT, CONTROL UNIT AND MOTOR VEHICLE

(71) Applicant: ZF Active Safety GmbH, Koblenz (DE)

(72) Inventor: Andreas Marx, Hartenfels (DE)

(73) Assignee: ZF Active Safety GmbH, Koblenz (DE)

(21) Appl. No.: 16/881,635

(22) Filed: May 22, 2020

(30) Foreign Application Priority Data
May 23, 2019 (DE) 102019113759.4

(51) Int. Cl. B60T 8/17; B60L 7/26; B60T 13/58; B60T 13/68; B60T 13/16

(52) U.S. Cl. CPC B60T 8/17; B60L 7/26; B60T 2270/604; B60T 13/686; B60T 13/161; B60T 13/586

(57) ABSTRACT

The present disclosure relates to a method for controlling a hydraulic brake system during a regenerative braking process. In the method, a displacement of a hydraulic fluid in the direction of a wheel brake is performed by means of a brake cylinder. The method comprises the step whereby an isolation valve which is assigned in terms of flow to the wheel brake and which is situated in a flow path of the hydraulic fluid is adjusted in the direction of a closed state in order to set a pressure difference between a region positioned upstream of the isolation valve in terms of flow and a region positioned downstream of the isolation valve in terms of flow. The present disclosure furthermore comprises a hydraulic brake system for a motor vehicle, a computer program product, a control unit and a motor vehicle.

### CROSS-REFERENCE TO RELATED APPLICATION

This application claims priority to German Patent Application No. 102019113759.4 filed May 23, 2019, the disclosure of which is incorporated herein by reference in its entirety.

### TECHNICAL FIELD

The present disclosure relates to a method for controlling a hydraulic brake system during a regenerative braking process. The present disclosure furthermore relates to a hydraulic brake system. The present disclosure furthermore relates to a computer program product, a control unit and a motor vehicle.

### BACKGROUND

Hydraulic brake systems are used for example in motor vehicles and serve primarily as a service brake for the motor vehicle. A braking operation is commonly performed by virtue of the driver of the motor vehicle actuating a brake pedal and a hydraulic fluid thus being displaced from a brake cylinder to at least one wheel brake, such that, at the wheel brake, a braking force prevails which acts on an associated vehicle wheel. This hydraulic braking force effected by means of the hydraulic fluid commonly corresponds to a braking force demand which is imparted by the driver through the actuation of the brake pedal.

Modem motor vehicles with a hydraulic brake system increasingly have a regenerative braking function in the following manner. In the presence of a braking demand input through actuation of the brake pedal, an electric machine operating in the generator mode is at least temporarily driven by the kinetic energy of the motor vehicle and supplies electrical energy, which can be utilized for example for charging an electrical energy store of the motor vehicle. The electric machine used for this purpose is commonly the electric machine which forms an electric drive for the motor vehicle, for example as a main drive or secondary drive, and which is operated as a generator during the course of an occurring regenerative braking process.

The generator operation of the electric machine is however associated with a drag torque which originates from the electric machine and which exerts a braking action on the motor vehicle. This braking action caused by the electric machine must be taken into consideration in the dimensioning of the hydraulic braking action to be applied in order to meet a braking demand input by the driver through actuation of the brake pedal. One possible concept in this regard is described in WO 2014/082885 A1.

The document discloses a method for controlling a hydraulic brake system during a regenerative braking process. In the method, at least a volume fraction of a hydraulic fluid which is displaced from a brake cylinder in the direction of a wheel brake is temporarily stored in a hydraulic accumulator via a pressure dissipation valve. It is made possible in this way that, in the case of a predefined braking demand and an associated displacement of the hydraulic fluid, a hydraulic braking action on the wheel brake is omitted at least to the extent that the electric machine can be incorporated for the purposes of generating electrical energy and, despite the generator braking action originating from the electric machine, the resulting overall braking action corresponds to the input braking demand.

### SUMMARY

It is an object of the present disclosure to propose at least one possibility for improving the previous concept of a regenerative braking operation.

Furthermore, to achieve the object, a computer program product having the features of claim 22, a control unit having the features of claim 23 and a motor vehicle having the features of claim 25 are proposed. Advantageous embodiments and/or refinements and/or aspects of the present disclosure will emerge from the subclaims, from the following description and from the figures.

An underlying method for controlling a hydraulic brake system, for example of a motor vehicle, during a regenerative braking process comprises the step whereby a displacement of a hydraulic fluid, in particular of a brake fluid, in the direction of a wheel brake is performed, in particular is commenced, by means of a brake cylinder. In particular, it is thus the case that the hydraulic fluid is displaced in the direction of the wheel brake by means of the brake cylinder. In particular, the brake cylinder and/or the wheel brake is a constituent part of the hydraulic brake system. In particular, the wheel brake is assigned to a vehicle wheel or is configured to be assigned to a vehicle wheel. In particular, the displacement of the hydraulic fluid implies a braking demand, in particular a present braking demand. For example, the displacement of the hydraulic fluid is caused directly or indirectly by means of an actuation of the brake pedal or of some other actuating device. For example, the displacement of the hydraulic fluid corresponds to a braking demand, in particular present braking demand, input by means of the brake pedal or the actuating device. For example, the actuation is performed by the driver of the motor vehicle.

The term “regenerative braking process” is to be understood in the present description to mean in particular a braking process in which, by means of at least one electric machine operated as a generator, kinetic energy is converted into electrical energy and this simultaneously results in a braking action, in particular a braking action which brakes the motor vehicle, which will hereinafter also be referred to as generator braking force or generator braking torque. This braking action is effected for example by a drag torque originating from the electric machine. For example, the kinetic energy results from the movement of the motor vehicle and/or from the rotational movement of the vehicle wheels. The electrical energy is preferably at least partially reused. For example, at least a part of the electrical energy is stored in an electrical energy store and is then available for use, for example for driving a motor vehicle and/or for the on-board electrical system of the motor vehicle.

In the following description, a hydraulic braking action effected by the wheel brake is referred to by way of example as hydraulic braking torque. This is to be understood in particular to mean the braking action of the wheel brake in relation to the vehicle wheel which is or can be assigned to the wheel brake. If multiple such wheel brakes are provided, each of these wheel brakes can impart a hydraulic braking torque, such that this results in a hydraulic braking torque, that is to say a hydraulic overall braking torque, which is made up of the hydraulic individual braking torques.

During the generator braking process, it is for example the case that an overall braking torque is present which is made up of the hydraulic braking torque and the generator braking torque effected by the electrical machine, wherein the generator braking torque relates for example to the vehicle wheel or vehicle axle, or to the motor vehicle with the vehicle wheel, to which the wheel brake is or can be assigned. In particular, the overall braking torque is distinct from a braking torque demand. In the present description, the expression “braking torque demand” is to be understood in particular to mean a measure for a desired braking action, which in the present case is already referred to generally as “braking demand”.

In one embodiment, the method comprises the step whereby an isolation valve which is assigned in terms of flow to the wheel brake and which is situated in a flow path of the hydraulic fluid is adjusted in the direction of a closed state in order to set a pressure difference between a region positioned upstream of the isolation valve in terms of flow and a region positioned downstream of the isolation valve in terms of flow, in particular in order to set the pressure difference to a predefined and/or desired pressure value. This measure has the aim of reducing, in targeted fashion, a hydraulic fluid throughflow or volume flow effected as a result of the displacement of the hydraulic fluid, that is to say of regulating and/or adjusting the hydraulic fluid throughflow or volume flow in the direction of a smaller volume flow. For this purpose, the change in the pressure difference, in particular the increase in the pressure difference, between the region positioned upstream and the region positioned downstream which occurs during the adjustment of the isolation valve in the direction of the closed state is used as a parameter in order to achieve a desired and/or corresponding state of actuation of the isolation valve. In the case of the isolation valve, use is made in particular of a throttle and/or shut-off element which serves for hydraulically isolating the wheel brake from the brake cylinder. For example, the isolation valve can be adjusted into the closed state in order to fully hydraulically isolate the wheel brake from the brake cylinder. For example, the isolation valve is a constituent part of an anti-lock braking system for the motor vehicle.

The isolation valve may be adjusted in the direction of the closed state such that the hydraulic braking torque effected by the wheel brake is set for example to a predefined and/or desired braking torque value, in particular present braking torque value. This measure has the aim of regulating, through the setting of the pressure difference or a setting of the pressure difference, the hydraulic braking torque effected by the wheel brake. For example, the pressure difference is set to such a predefined and/or desired pressure value that the predefined and/or desired braking torque value for the hydraulic braking torque is achieved. In particular, for this purpose, the isolation valve is correspondingly adjusted.

In addition or alternatively, the isolation valve may be adjusted in the direction of the closed state such that a reaction force is set for example to a predefined and/or desired force value, in particular present force value, wherein the reaction force acts on an actuated brake pedal or on some other actuating device which actuates the brake cylinder. This measure has the aim of regulating the reaction force on the brake pedal or on the actuating device through the setting of the pressure difference or a setting of the pressure difference. For example, the pressure difference is set to such a predefined and/or desired pressure value that the predefined and/or desired force value for the reaction force is achieved. In particular, for this purpose, the isolation valve is correspondingly adjusted.

In addition or alternatively, a combination and/or superposition of the two preceding steps may be performed or be present. For example, in this case, the isolation valve is adjusted in the direction of the closed state such that, firstly, the hydraulic braking torque effected by the wheel brake is set, for example to the predefined and/or desired braking torque value or a predefined and/or desired braking torque value, and, secondly, the above-described reaction force is set, for example to the predefined and/or desired force value or a predefined and/or desired force value.

In order to set the pressure difference, in particular to the predefined and/or desired pressure value, the isolation valve can be adjusted between a closed position and an open position. This promotes an exact setting and/or regulation of the pressure difference, because not only a closing movement but additionally also an opening movement of the isolation valve can be utilized. For example, it is thereby made possible to set the pressure difference, in particular to the predefined and/or desired pressure value, by virtue of the isolation valve performing a back-and-forth movement between the closed position and the open position.

In a further embodiment, the isolation valve is actuated by means of an associated actuator in order to set the pressure difference, in particular to the predefined and/or desired pressure value or a predefined and/or desired pressure value. For example, for this purpose, the actuator is activated by means of an electrical voltage signal and/or an electrical current signal, for example utilizing electronic closed-loop and/or open-loop control. One possible refinement consists in that the actuator is activated by means of a pulse-width-modulated electrical signal, for example a pulse-width-modulated electrical voltage signal. For example, the pressure difference is determined by virtue of a first fluid pressure present in the region positioned upstream being measured and a second fluid pressure present in the region positioned downstream being estimated. These measures have the aim of promoting a technically simple method implementation in order to perform the activation of the isolation valve or the adjustment of the isolation valve and/or the setting of the pressure difference.

In one possible embodiment, the method comprises the step whereby a pressure dissipation valve which is positioned between the isolation valve and the wheel brake in terms of flow is situated in an open position, or is adjusted in the direction of an open position, in order to conduct at least a volume fraction of the hydraulic fluid into an accumulator, in particular buffer accumulator. In this way, a measure is implemented whereby a hydraulic braking action on the wheel brake corresponding to the displacement of the hydraulic fluid is omitted, that is to say the hydraulic braking torque effected by the wheel brake is lower than it would be as a result of the displacement of the hydraulic fluid in the case of a closed pressure dissipation valve. For example, it is thereby made possible that, despite the displacement of the hydraulic fluid, the hydraulic braking torque effected by the wheel brake is zero or approximately zero. In this way, despite the displacement of the hydraulic fluid and the braking torque demand thus initiated, it is made possible for the hydraulic braking torque to be kept at such a level that a gap present between the required overall braking torque and the generator braking torque effected by means of the electric machine is closed by means of the hydraulic braking torque, in order, for example, to cover the braking torque demand.

The adjustment of the pressure dissipation valve into the open position or an open position causes, for example, a lowering of the fluid pressure in the flow path of the hydraulic fluid. In this respect, this measure is suitable for influencing or varying the fluid pressure in the region positioned downstream of the isolation valve and/or the fluid pressure of the region positioned upstream of the isolation valve. The adjustment of the pressure dissipation valve into the open position or an open position can thus be utilized for setting a pressure difference between the region positioned upstream and the region positioned downstream. The same is possible by means of an adjustment of the pressure dissipation valve in the direction of a closed position or into the closed position. In this way, too, the fluid pressure can be influenced, and this is therefore expedient at least as a supporting measure for the setting of the pressure difference.

In another embodiment, the method comprises the step whereby the above-described pressure dissipation valve is situated in a closed state, or is adjusted in the direction of a closed state, in order to keep the above-described accumulator hydraulically separate, or to at least partially hydraulically separate the accumulator, from the wheel brake. In this way, a measure is implemented for increasing the hydraulic braking torque effected by the wheel brake or keeping the hydraulic braking torque at a level corresponding to the displacement of the hydraulic fluid, and thus compensating for, or adapting to, changes in the level of the braking torque demand and/or in the level of the provided generator braking torque.

In a further embodiment, by means of a pump, at least one volume fraction of the hydraulic fluid is conveyed out of the accumulator and conducted for example into the region positioned upstream of the isolation valve. In this way, too, a measure is implemented for being able to influence the pressure difference between the region positioned upstream and the region positioned downstream. The pump and the conveyance of the hydraulic fluid thus effected, in particular the conveyance of the at least one volume fraction of the hydraulic fluid out of the accumulator, promote the setting of the pressure difference between the region positioned upstream and the region positioned downstream.

An underlying hydraulic brake system, for example for a motor vehicle, in particular for carrying out the method described above, comprises a brake cylinder and a wheel brake which are hydraulically connected to one another via a feed line, wherein the brake cylinder is configured to displace a hydraulic fluid in the direction of the wheel brake, and the wheel brake is configured to impart a hydraulic braking force or a hydraulic braking torque by means of the hydraulic fluid. The hydraulic brake system furthermore comprises an isolation valve, which is preferentially situated in an open position, which is fluidically assigned to the feed line and which is configured to close the feed line. Furthermore, the hydraulic brake system comprises a return line for returning at least a volume fraction of the hydraulic fluid from a region positioned downstream of the isolation valve into a region positioned upstream of the isolation valve.

In the present description, the “region positioned downstream” is to be understood in particular to mean that receiving volume of the brake system for receiving hydraulic fluid which is positioned downstream of the isolating valve as viewed in the flow direction with respect to the feed line, that is to say in the direction from the brake cylinder to the wheel brake. For example, the region positioned downstream comprises a hydraulic receiving volume of the feed line which is positioned downstream of the isolating valve, and/or comprises a hydraulic receiving volume of the wheel brake.

In the present description, the “region positioned upstream” is to be understood in particular to mean that receiving volume of the brake system for receiving hydraulic fluid which is positioned upstream of the isolating valve as viewed in the flow direction with respect to the feed line, that is to say in the direction from the brake cylinder to the wheel brake. For example, the region positioned upstream comprises a hydraulic receiving volume of the feed line which is positioned upstream of the isolating valve and/or comprises a hydraulic receiving volume of the brake cylinder and/or of a provided reservoir/replenishment vessel for the hydraulic fluid.

The hydraulic brake system furthermore comprises a pressure dissipation valve, a pump and an accumulator, which are fluidically assigned to the return line. The pump is configured to convey at least a volume fraction of the hydraulic fluid. The accumulator is configured to store at least a volume fraction of the hydraulic fluid, in particular to store the same under a counterpressure. Furthermore, the pressure dissipation valve is configured to open the return line. For example, as viewed in the direction of a return from the region positioned downstream into the region positioned upstream, the pressure dissipation valve, the pump and the accumulator are arranged in the sequence: pressure dissipation valve, accumulator, pump.

Also provided in the hydraulic brake system is a control unit which is connected in signal-exchanging fashion to the isolation valve, the pressure dissipation valve and the pump. In particular, the control unit is configured to activate and/or communicate with the isolation valve and/or the pressure dissipation valve and/or the pump. For example, the control unit is furthermore connected in signal-exchanging fashion to an electric machine which is utilized during regenerative braking. In particular, the control unit is configured to control the electric machine and/or communicate with the electric machine. For example, the control unit is furthermore connected in signal-exchanging fashion to an actuating device for actuating the brake cylinder, such as for example a brake pedal or a brake lever, and/or to at least one sensor element assigned to the actuating device, such as for example a travel sensor, in particular a pedal travel sensor, and/or a force sensor, in particular a pedal force sensor.

In particular, the control unit is configured to communicate with the actuating device and/or with the at least one sensor element and/or to receive signals from the actuating device and/or from the at least one sensor element, and to take the signals into consideration with regard to an activation of the isolation valve and/or of the pressure dissipation valve and/or of the pump and/or of the electric machine. The control unit may be in hardware form and/or software form, for example in the form of a computer program or computer program module, or may be a constituent part of an item of hardware and/or an item of software.

In one embodiment, the control unit is configured such that, in the presence of an actuation of the brake cylinder and in particular in the presence of a generator braking torque effected by the electric machine, the control unit activates the isolation valve for adjustment in the direction of a closed state in order to set a pressure difference between the region positioned upstream and the region positioned downstream. In this embodiment, by means of the provided refinement of the control unit, a possibility is proposed for carrying out the above-described method and thus achieving the advantages described with regard to the method.

The control unit may be configured to perform the activation of the isolation valve for adjustment in the direction of the closed state such that the hydraulic braking torque effected by the wheel brake is set. Here, the hydraulic braking torque may also be set to a value of zero or a value of approximately zero. In addition or alternatively, the control unit may be configured to perform the activation of the isolation valve for adjustment in the direction of the closed state such that a reaction force which acts on an actuated brake pedal or on some other actuating device which actuates the brake cylinder is set. Also, the control unit may be configured to perform a combination and/or superposition of the two above-stated functions. For example, the control unit is then configured to perform the activation of the isolation valve for adjustment in the direction of the closed state such that, firstly, the hydraulic braking torque effected by the wheel brake is set and, secondly, the above-described reaction force is set.

In the following embodiments, too, by means of the provided refinement of the control unit, possibilities are proposed for carrying out the above-described method and thus achieving the advantages described with regard to the method. For example, in one embodiment, the control unit is configured to activate the isolation valve for adjustment in a direction away from the closing state, in particular in the direction of an open position or into the open position, in order to set the pressure difference between the region positioned upstream and the region positioned downstream. For example, the control unit is configured to perform the activation of the isolation valve such that the isolation valve performs a back-and-forth movement between the closed state and/or a closed position, on the one hand, and the above-described open position or an open position, on the other hand, in order to set the pressure difference.

In a further embodiment, the isolation valve is assigned an actuator which is connected in signal-exchanging fashion to the control unit and which is configured to actuate the isolation valve. For example, the actuator is a structural unit with drive technology, which converts a received electrical signal into a mechanical movement in order to thereby actuate the isolation valve. For example, the at least one actuator is configured to be activated by means of electrical voltage signals and/or electrical current signals, in particular pulse-width-modulated electrical signals. For example, the control unit is configured to activate the actuator by means of a pulse-width-modulated electrical signal, in particular an electrical voltage signal and/or an electrical current signal, for adjustment of the isolation valve in order to set the pressure difference between the region positioned upstream and the region positioned downstream. For example, the control unit is furthermore configured to determine the pressure difference on the basis of measured values relating to a first fluid pressure prevailing in the region positioned upstream and estimated values relating to a second fluid pressure prevailing in the region positioned downstream.

In a further embodiment, the control unit is configured to activate the pressure dissipation valve for adjustment into an open position in order to conduct at least a volume fraction of the hydraulic fluid into the accumulator and for example thereby assist the setting of the pressure difference. The control unit may also be configured to activate the pump to impart a conveying action in order to convey at least a volume fraction of the hydraulic fluid out of the accumulator and thus set the pressure difference between the region positioned upstream and the region positioned downstream or at least assist the setting of the pressure difference.

Provision may be made whereby the isolation valve and/or the pressure dissipation valve and/or the pump and/or the accumulator and/or the control unit are for example a constituent part of an anti-lock braking system (ABS) or of a driving dynamics control system (ESC) of the motor vehicle or for the motor vehicle. This promotes cost advantages, because the components involved then perform a multiple function or a multiple use. In particular, in the case of the above-described functions of the control unit, the isolation valve remains in the open position or in an open position, such that a hydraulic connection between the brake cylinder and the wheel brake and/or between the accumulator and the wheel brake is maintained.

In the present description, the expression “wheel brake” is to be understood in particular to mean a friction brake, such as for example a disk brake or a drum brake. In particular, the wheel brake is configured to be utilized as a service brake. For example, the wheel brake is assigned to a vehicle wheel or is configured to be assigned to a vehicle wheel.

In the present description, the expression “brake cylinder” is to be understood in particular to mean a device which generates fluid pressure. The brake cylinder may comprise a pressure piston which is for example held displaceably in a cylinder and which, by means of a displacement movement of the pressure piston relative to the cylinder, effects a displacement of a hydraulic fluid or of a hydraulic fluid volume. The expression “brake cylinder” in particular also encompasses a conveying pump or similar conveying device as a device which generates fluid pressure. The brake cylinder may be a master brake cylinder. For example, the brake cylinder is a master brake cylinder such as is common in conventional hydraulic brake systems. For example, the brake cylinder comprises a reservoir and/or a replenishment vessel for the hydraulic fluid.

In particular, the brake cylinder interacts with an actuating device, or the brake cylinder is configured to interact with an actuating device. The actuating device may be the actuating device already described above. In particular, an actuation of the actuating device has the effect, at the brake cylinder, that a displacement of the hydraulic fluid occurs. For example, an actuation of the brake cylinder is realized mechanically, in particular purely mechanically, or electrically or electromechanically.

For example, the actuating device comprises a brake pedal or a brake lever which acts, for example via a piston rod, on the brake cylinder so as to generate fluid pressure. In addition or alternatively, the actuating device may comprise an electric machine, in particular an electric motor, wherein an output shaft of the electric machine is coupled in terms of drive to the brake cylinder in order to thereby actuate the brake cylinder. The actuating device may be actuated manually for example by the driver of the motor vehicle or automatically or in self-acting fashion by means of a vehicle controller, for example the vehicle controller described above.

In the present description, the expression “isolating valve” is to be understood in particular to mean a shut-off element by means of which the wheel brake can be at least partially hydraulically decoupled, that is to say isolated, from the brake cylinder. In particular, the isolation valve is configured to close and open the feed line. In particular, the isolation valve is configured to completely close or at least partially close the feed line. For example, the isolation valve has a passage for fluid, in particular the hydraulic fluid, which passage is of variable cross section. For example, the isolation valve is configured to be adjusted between a closed position and an open position, for example with regard to the passage, wherein, in the closed position, the feed line is at least partially or completely dosed, that is to say shut off. In the “closed state” described above, the isolation valve is situated for example in the closed position. If the isolation valve is adjusted in a direction away from the closed state, it is for example the case that the cross section of the passage is increased in size. If the isolation valve is adjusted in a direction toward the closed state, it is for example the case that the cross section of the passage is decreased in size.

For example, the isolation valve is configured to be electrically and/or electromagnetically actuated, in particular in order to be adjusted or switched, for example adjusted and/or switched in continuously variable or stepped and/or digital or analog fashion, between the closed position and the open position. For example, the isolation valve is or comprises a 2/2 directional valve, which, for example, assumes the open position in a non-actuated state and the closed position in an actuated state. If it is an electrically or electromagnetically actuated isolation valve, it is for example electrically deenergized in the non-actuated state and electrically energized in the actuated state. For example, the isolation valve is a valve with an NO function. The NO function is to be understood in particular to mean that the valve is open in the electrically deenergized state. Such a valve may also be referred to as a “normally open” NO valve. For example, the isolation valve is a preferably directly controlled solenoid valve with an NO function.

In the present description, the expression “pressure dissipation valve” is to be understood in particular to mean a shut-off element by means of which the return line can be at least partially or fully opened, for example proceeding from a shut-off state. For example, the pressure dissipation valve has a passage for fluid, in particular the hydraulic fluid, which passage is of variable cross section. For example, the pressure dissipation valve is configured to be adjusted between a closed position and an open position, for example with regard to the passage, wherein, in the open position, the return line is at least partially or completely opened. In the “closed state” described above, the pressure dissipation valve is situated for example in the closed position. If the pressure dissipation valve is adjusted in a direction away from the closed state, it is for example the case that the cross section of the passage is increased in size. If the pressure dissipation valve is adjusted in a direction toward the closed state, it is for example the case that the cross section of the passage is decreased in size.

For example, the pressure dissipation valve is configured to be electrically or electromagnetically actuated, in order to be adjusted or switched, for example adjusted and/or switched in continuously variable or stepped and/or digital or analog fashion, between the closed position and the open position. For example, the pressure dissipation valve is or comprises a 2/2 directional valve, which, for example, assumes the closed position in a non-actuated state and the open position in an actuated state. If it is an electrically or electromagnetically actuated pressure dissipation valve, it is for example electrically deenergized in the non-actuated state and electrically energized in the actuated state. For example, the pressure dissipation valve is a valve with an NC function. The NC function is to be understood in particular to mean that the valve is closed in the electrically deenergized state. Such a valve may also be referred to as a “normally closed” NC valve. For example, the pressure dissipation valve is a preferably directly controlled solenoid valve with an NC function.

In the present description, the expression “pump” is to be understood in particular to mean a conveying device for conveying hydraulic fluid. For example, the pump is a rotary pump, in particular a radial piston pump or an axial piston pump. In particular, the rotary pump comprises at least one, preferably multiple, for example two to six, working piston(s), which perform(s) or can perform a reciprocating movement for the purposes of conveying the hydraulic fluid. For example, the pump comprises an electric machine, for example an electric motor, which serves for driving the pump. The electric machine is for example configured to receive electrical control signals and output corresponding control signals to the pump.

The expression “accumulator” is to be understood in particular to mean a hydro accumulator or hydraulic accumulator which is for example configured to store the hydraulic fluid under pressure. That volume fraction of the hydraulic fluid which is conducted to the accumulator is thus received therein counter to a resetting force of the accumulator. The accumulator may be designed such that a gas or a spring element is compressed during a process of filling with the hydraulic fluid. For example, the accumulator is a buffer accumulator which is configured to temporarily buffer-store the at least one volume fraction of the hydraulic fluid.

In the present description, the expression “control unit” is to be understood in particular to mean an electronic unit of an item of computer hardware which, in conjunction with the hydraulic brake system and for example an electric machine utilized during regenerative braking, controls particular processes and/or sequences. The control unit may have a digital processing unit, which comprises for example a microprocessor unit (CPU). The CPU may be connected in data-exchanging and/or signal-exchanging fashion to a memory system and/or bus system. The control unit may have one or more programs or program modules. The digital processing unit may be designed such that commands that are implemented as a program stored in a memory system are executed, input signals are received from a data bus system, and/or output signals are output to a data bus system. A memory system may have one or more, in particular different, memory media. The memory media may in particular be optical, magnetic, solid-state memory media and/or other, preferably nonvolatile memory media.

In the present description, the expression “braking torque limit” is to be understood in particular to mean a generator limit torque that is for example defined by the electric machine for system reasons. This can also be understood to mean a maximum generator braking torque provided by the electric machine.

According to one aspect, the present disclosure furthermore relates to a computer program product having program code, which is stored on a computer-readable medium, for carrying out an embodiment of the above-described method.

According to a further aspect, the present disclosure relates to a control unit, in particular for the above-described hydraulic brake system, comprising the above-described computer program product.

According to a further aspect of the present disclosure, a motor vehicle having the above-described hydraulic brake system and/or having the above-described computer program product and/or having the above-described control unit is provided.

According to one embodiment, the motor vehicle comprises at least one vehicle wheel and at least one electric machine connected in terms of drive to the vehicle, which electric machine is configured to be utilized as a generator during a braking process of the motor vehicle. The electric machine may be the electric machine described above.

In particular, the electric machine is configured to be present only in a generator mode or to be switched, in particular manually or automatically switched, into a generator mode upon an onset of a braking process of the motor vehicle, in particular upon an onset of a displacement of the hydraulic fluid by means of the brake cylinder. For example, the electric machine is an electric drive of the motor vehicle, which, for example as a main drive or secondary drive, acts with driving action on the at least one vehicle wheel and, during a braking process of the motor vehicle, is utilized as a generator in order, for example, to charge an electrical energy store of the motor vehicle.

### BRIEF DESCRIPTION OF THE DRAWINGS

Further details and features of the present disclosure will emerge from the following description of two exemplary embodiments on the basis of the drawing. In the drawing:

FIG. 1 shows a possible embodiment of a hydraulic brake system, which is suitable for carrying out a regenerative braking process, in a schematic illustration, and

FIG. 2 shows a further possible embodiment of a hydraulic brake system, which is suitable for carrying out a regenerative braking process, in a schematic illustration.

### DETAILED DESCRIPTION

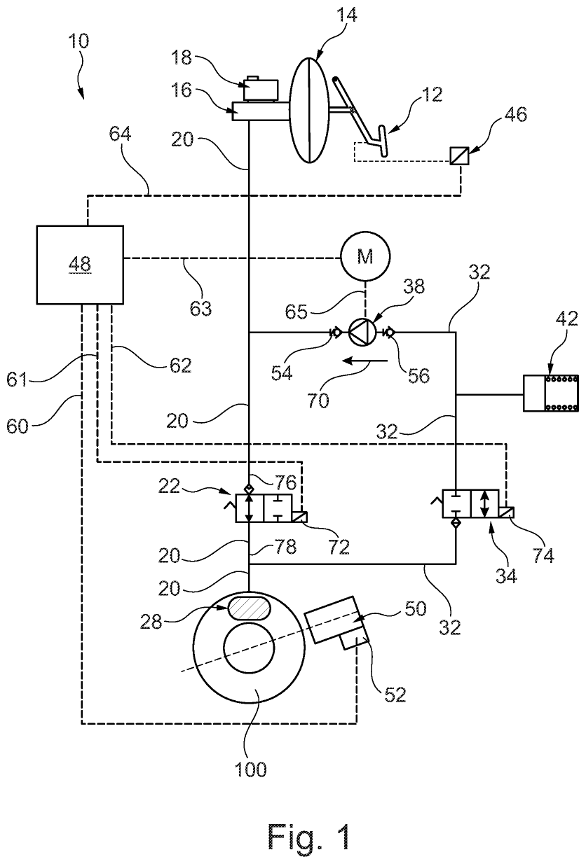

FIG. 1 shows a possible embodiment of a hydraulic brake system 10 which is used for example in a motor vehicle. In FIG. 1, the hydraulic brake system 10 is illustrated by way of example in conjunction with one vehicle wheel 100. The hydraulic brake system 10 is configured to be able to perform a regenerative braking process. In the regenerative braking process, the kinetic energy of the motor vehicle is utilized in order to drive an electric machine 50 in generator mode and thereby generate electrical energy. The electrical energy can be utilized for example to charge an electrical energy store of the motor vehicle. By way of example, in FIG. 1, the electric machine 50 is assigned to the vehicle wheel 100 in order to illustrate that the electric machine 50 is driven by the movement of the vehicle, that is to say by the rotation of the vehicle wheel 100. The electric machine 50 is preferably a constituent part of an electric drive of the motor vehicle, which serves for example for driving the vehicle wheel 100. During a regenerative braking process, the electric drive is utilized as a generator.

The hydraulic brake system 10 comprises, for example, a brake cylinder 16 and a wheel brake 28, which are hydraulically connected to one another via a feed line 20. The brake cylinder 16 is configured to displace a hydraulic fluid in the direction of the wheel brake 28. The wheel brake 28 is configured to exert a braking force, for example in the form of a friction force, on the vehicle wheel 100 by means of the hydraulic fluid. The hydraulic brake system 10 is preferably assigned a brake pedal 12, by means of which the brake cylinder 16 is to be actuated. The brake cylinder 16 is preferably assigned a reservoir 18 for the purposes of storing hydraulic fluid for the hydraulic brake system 10 in the reservoir. The reservoir 18 may have an inlet opening in order to be refilled or filled via the inlet opening.

To boost an actuating force input by means of the brake pedal 12, for example by a driver of the motor vehicle, a brake force booster 14 may be provided. The brake force booster 14 preferably boosts the actuating force in a known manner in accordance with a pneumatic, electrohydraulic or electromechanical principle. In order, for automatic vehicle control, to actuate the brake cylinder independently of an actuation of the brake pedal by the driver, it is also possible for an electrically controlled brake force booster (EBB; Electronic Brake Booster) to be provided.

The hydraulic brake system 10 preferably furthermore comprises an isolation valve 22 which is fluidically assigned to the feed line 20 and which is configured to close the feed line. For example, it is the intention in this way for the wheel brake 28 to be able to be at least partially or entirely hydraulically isolated from the brake cylinder 16. The isolation valve 22 is preferably provided for adjustment between a closed position and an open position in order to close or shut off, in particular entirely or at least partially close or shut off, the feed line 20. Preferably, in the closed position of the isolation valve 22, the feed line 20 is shut off, in particular fully shut off or at least largely or substantially shut off, and, in the open position, the feed line 20 is open, in particular substantially open or fully open.

Preferably, the hydraulic brake system 10 furthermore comprises a return line 32 which serves for returning at least a volume fraction of the hydraulic fluid from a region 78 positioned downstream of the isolation 22 valve into a region 76 positioned upstream of the isolation valve 22. For example, the return line 32 is connected in terms of flow by means of one end to the feed line 20 in a region between the isolation valve 22 and the wheel brake 28. Preferably, the return line 32 is connected in terms of flow by means of another end to the feed line 20 in a region between the isolation valve 22 and the brake cylinder 16. In this way, at least a volume fraction of the hydraulic fluid can be returned from the wheel brake 28 into the feed line 20, bypassing the isolation valve 22.

Preferably, the return line 32 is fluidically assigned a pressure dissipation valve 34, a pump 38 and an accumulator 42. The pump 38 is configured to convey at least a volume fraction of the hydraulic oil, in particular in a return direction 70. Preferably, by means of a conveying action of the pump 38 in the return direction 70, the at least one volume fraction of the hydraulic fluid is conveyed in the direction of the region 76 positioned upstream. The accumulator 42 is configured to store at least a volume fraction of the hydraulic fluid, in particular to store the same under pressure, in particular to buffer-store the same.

The pressure dissipation valve 34 is configured to open and close the return line 32. The pressure dissipation valve 34 is preferably provided for adjustment between a closed position and an open position in order to open, in particular entirely or at least partially open, the return line 32. Preferably, in the open position of the pressure dissipation valve 34, the return line 32 is open, in particular at least partially open or fully open, and, in the closed position, the return line 32 is closed or shut off, in particular entirely shut off or at least largely or substantially shut off. Preferably, as viewed in the return direction 70 of the hydraulic fluid, the pressure dissipation valve 34, the pump 38 and the accumulator 42 are arranged in the sequence in which the pressure dissipation valve 34 comes first, and is followed either by the pump 38 or the accumulator 42. By opening the return line 32, the accumulator 42 is thus filled with the returned volume fraction of the hydraulic fluid.

Preferably, the hydraulic brake system 10 furthermore comprises a control unit 48, in particular an electrical control unit, for activating the isolation valve 22 and/or the pressure dissipation valve 34 and/or the pump 38. For example, for this purpose, the control unit 48 is connected in signal-exchanging fashion to the isolation valve 22 and/or to the pressure dissipation valve 34 and/or to the pump 38 via a corresponding signal line 61 or 62 or 63 respectively, in particular electrical signal line. Preferably, the isolation valve 22 and/or the pressure dissipation valve 34 and/or the pump 38 has in each case one electrical receiver unit in order to process the control signals transmitted by the control unit 48 and initiate or perform a corresponding actuation of the isolation valve 22 or of the pressure dissipation valve 34 or of the pump 38 respectively.

For example, for this purpose, the pump 38 may have a corresponding actuating device, such as for example an electric drive motor M, which is activated by the control line 63 and which acts on the pump 38, in particular on a working cylinder of the pump 38, via a mechanical and/or hydraulic and/or electromagnetic actuation connection 65. Preferably, both control signals and state signals, for example signals with information items regarding monitored or detected parameters, are to be transmitted via the signal lines 61, 62, 63.

It is for example furthermore possible for the isolation valve 22 to be assigned an actuator 72, and/or for the pressure dissipation valve 34 to be assigned an actuator 74. By means of the respective actuator 72 or 74, the associated isolation valve 22 or pressure dissipation valve 34 is actuated, for example mechanically actuated. The actuator 72 or 74 itself may be activated by means of the respective control line 61 or 62 respectively. The signals transmitted via the signal lines 61, 62, 63 may be electrical current signals and/or electrical voltage signals. The electrical signals are preferably pulse-width-modulated (PWM signals).

The control unit 48 is preferably connected in signal-exchanging fashion to the electric machine 50 for example via a signal line 60, in order to transmit control signals from the control unit 48 to the electric machine 50 and/or conversely in order to transmit control signals or signals containing information items regarding an operating state of the electric machine 50, for example, to the control unit 48. For this purpose, the electric machine 50 may have a control unit 52 which communicates via the signal line 60 with the control unit 48t and which activates, in particular directly activates, the electric machine 50.

Preferably, the control unit 48 is furthermore connected in signal-exchanging fashion via a signal line 64 to a sensor element assigned to the brake pedal 12, in particular a pedal travel sensor 46. The pedal travel sensor 46 serves for detecting a pedal travel of the brake pedal 12. Via the signal connection between the pedal travel sensor 46 and the control unit 48, the control unit 48 can take into consideration information items relating to the pedal travel.

The control unit 48 is preferably configured such that, in the presence or upon an onset of an actuation of the brake cylinder 16 and in particular in the presence or upon an onset of a generator braking torque originating from the electric machine 50, the control unit activates the pressure dissipation valve 34 for adjustment in the direction away from a closed state, in particular for adjustment in the direction of an open position. Preferably, the pressure dissipation valve 34 is activated for adjustment in a direction away from the closed state in order to conduct at least a volume fraction of a hydraulic fluid displaced by means of the actuation of the brake cylinder 16 into the accumulator 42.

The control unit 48 is preferably configured such that, after the adjustment of the pressure dissipation valve 34 away from the closed state, the control unit activates the pressure dissipation valve 34 for resetting in the direction of the closed state, in particular into the closed state, in order to realize an increase of the hydraulic braking torque effected by the wheel brake 28, for example proceeding from a value of zero or some other torque value. Such a situation may exist if the overall braking torque, that is to say the sum of the hydraulic braking torque and of the generator braking torque, is lower than the braking torque demand input by means of the displacement of the hydraulic fluid. By means of the adjustment of the pressure dissipation valve in the direction of the closed state or into the closed state, this gap between the overall braking torque and the braking torque demand can be closed.

The control unit 48 is preferably configured such that, after the adjustment of the pressure dissipation valve 34 in the direction of the closed state or into the closed state, the control unit activates the pump 38 to impart a conveying action in order to convey at least a volume fraction of the hydraulic fluid stored in the accumulator 42 in the direction of the wheel brake 28 and thus realize an increase of the hydraulic braking torque effected by the wheel brake 28. Such a situation may exist if, despite the adjustment of the pressure dissipation valve 34 in the direction of the closed state or into the closed state, the overall braking torque is still lower than the braking torque demand and, for example, the overall braking torque is higher than the torque limit of the electric machine 50.

The control unit 48 is configured such that, in the presence of an actuation of the brake cylinder 16 and in particular in the presence or upon the onset of a generator braking torque originating from the electric machine 50, the control unit activates the isolation valve 22 for adjustment in the direction of a closed state in order, by means of the isolation valve 22, to set a pressure difference between the region 76 positioned upstream and the region 78 positioned downstream. The control unit 48 is preferably configured to determine the pressure difference from measured values and estimated values, wherein the measured values relate to a fluid pressure in the region 76 positioned upstream and the estimated values relates to a fluid pressure in the region 78 positioned downstream.

The control unit 48 is preferably configured to perform the activation of the isolation valve 22 for adjustment in the direction of the closed state such that the hydraulic braking torque effected by the wheel brake 28 is set. In particular, the activation of the isolation valve 22 for adjustment in the direction of the closed state is to be performed such that the increase in the fluid pressure in the wheel brake 28 and thus the increase of the hydraulic braking torque effected by the wheel brake 28 are metered. The control unit 48 is preferably furthermore configured such that the activation of the isolation valve 22 for adjustment in the direction of the closed state is performed such that a reaction force which acts on the actuated brake pedal 12 is set.

The control unit 48 is preferably configured such that, after the adjustment of the pressure dissipation valve 34 in the direction of the closed state, the control unit activates the pressure dissipation valve 34 for adjustment in the direction away from the closed state in order to conduct at least a volume fraction of the hydraulic fluid into the accumulator again 42, and the control unit furthermore activates the isolation valve 22 for adjustment in the direction of a closed state in order to at least partially hydraulically isolate the wheel brake 28 from the brake cylinder 16 and/or from the accumulator 42. For example, the control unit 48 is configured such that, after the adjustment of the pressure dissipation valve 34 in the direction of the closed state, the control unit activates the pressure dissipation valve 34 for adjustment in the direction away from the closed state and subsequently or simultaneously activates the isolation valve 22 for adjustment in the direction of the closed state.

Before a regenerative braking process begins, the hydraulic brake system 10 is in an initial state. Preferably, in the initial state, the isolation valve 22 is in an open position (FIG. 1), such that the feed line 20 is open, that is to say a hydraulic connection exists between the wheel brake 28 and the brake cylinder 16. Preferably, in the initial state, the pressure dissipation valve 34 is in a closed state (FIG. 1), such that the return line 32 is closed or shut off. Preferably, in the initial state, no conveying of hydraulic fluid is performed by the pump 38, that is to say the pump 38 does not impart a conveying action. The accumulator 42 is preferably in a discharged or at least substantially discharged state (FIG. 1).

The hydraulic brake system 10 permits functioning as described below on the basis of the example of a motor vehicle equipped with the hydraulic brake system 10, wherein, by way of example, reference is made only to the one vehicle wheel 100 of FIG. 1.

The motor vehicle performs a travelling movement, for example with an accelerator pedal actuated. If the electric machine 50 is utilized as a drive, the electric machine 50 is in a motor mode. Furthermore, the hydraulic brake system 10 is in the initial state described above. In order to initiate a braking process, it is for example the case that the actuation of the accelerator pedal is ended and, for example, an actuation of the brake pedal 12 is commenced. The electric machine 50 is preferably prepared for use as a generator, for example is switched into the generator mode.

Preferably, the actuation of the brake pedal 12 or the onset of an actuation of the brake pedal 12 is identified or detected by the control unit 48 of the hydraulic brake system 50. For example, the pressure dissipation valve 34 is hereupon activated by the control unit 48 for adjustment into an open position, and an opening of the return line 32 occurs. As a result of the actuation of the brake pedal 12, a displacement of a hydraulic fluid from the brake cylinder 16 in the direction of the wheel brake 28 is effected via the feed line 20. Owing to the opened return line 32, at least a volume fraction of the hydraulic fluid is conducted into the accumulator 42, such that a hydraulic braking force corresponding to the displacement of the hydraulic fluid is not generated at the wheel brake 28.

By means of the actuation of the brake pedal 12, a braking torque demand is input, which must be matched by generation of a braking torque, for example of a braking torque at the vehicle wheel 100. For this purpose, the drag torque originating from the electric machine 50 is utilized, which acts as a braking torque on the moving system, that is to say in the present case on the motor vehicle or the vehicle wheel 100.

In the present open position of the pressure dissipation valve 34, the generator braking torque effected by the electric machine 50 can, with rising braking torque demand, basically be utilized until such time as the braking torque limit of the electric machine 50 has been reached. Only then is a hydraulic braking torque required or must a hydraulic braking torque be increased. For example, this is then performed by means of an adjustment of the pressure dissipation valve 34 in the direction of a closed state. For this purpose, the pressure dissipation valve 34 is correspondingly activated by the control unit 48. Additionally, the control unit 48 may activate the pump 38 to impart a conveying action, whereby the outflow of at least a volume fraction of the hydraulic fluid from the accumulator 42 in the direction of the wheel brake 28 is effected or at least assisted. By means of the hydraulic braking torque, it is then possible, together with the generator braking torque, for an overall braking torque to be provided which covers the braking torque demand.

With regard to the isolation valve 22, the initial state of the hydraulic brake system 10 can be maintained. The isolation valve 22 thus remains in the open position. The control unit 48 may activate the isolation valve 22, for example in individual phases of the above-described functioning of the hydraulic brake system 10, in order to effect an adjustment of the isolation valve 22. The isolation valve 22, which is fluidically assigned to the feed line 20, makes it possible for the wheel brake 28 to be at least partially or fully hydraulically isolated from the brake cylinder 16 and preferably also from the accumulator 42. For this purpose, the isolation valve 22 is to be adjusted from the open position in the direction of a closed state or into the closed state.

By means of the adjustment of the isolation valve 22, it is possible, with regard to a fluid pressure prevailing in the feed line 20, for a pressure difference to be built up or varied. This pressure difference is defined by a fluid pressure that takes effect in the region 76 positioned upstream of the isolation valve 22 in terms of flow in relation to a fluid pressure prevailing in the region 78 positioned downstream of the isolation valve 22 in terms of flow. By virtue of the control unit 48 activating the isolation valve 22 in order to realize a targeted adjustment, the pressure difference can be set, for example set to a predefined or desired pressure value.

For example, the adjustment of the isolation valve 22 is utilized in order to influence the hydraulic braking torque effected by the wheel brake 28. For example, the control unit 48 activates the isolation valve 22 for adjustment in the direction of the closed state in order to targetedly influence or set the increase of the fluid pressure in the wheel brake 28 and thus the increase of the hydraulic braking torque effected by the wheel brake 28. For this purpose, the control unit 48 utilizes information items relating to the prevailing pressure difference, in particular present pressure difference, between the region 76 positioned upstream and the region 78 positioned downstream.

In addition or alternatively, a pedal force simulator may be realized by means of the isolation valve 22. Then, the adjustment of the isolation valve 22 is utilized in order to set a reaction force which acts on the actuated brake pedal 12. Here, the reaction force is a generated opposing force in relation to the actuating force input by means of the brake pedal 12, which is imparted for example by the driver of the motor vehicle. For example, the control unit 48 activates the isolation valve 22 for adjustment in the direction of the closed state in order to set a counterpressure at the brake cylinder 16 and thus the reaction force on the brake pedal 12. For this purpose, the control unit 48 utilizes information items relating to the prevailing pressure difference, in particular present pressure difference, between the region 76 positioned upstream and the region 78 positioned downstream.

The setting of the differential pressure is performed for example by virtue of the actuator 72 assigned to the isolation valve 22 being activated by means of an electrical voltage signal and/or an electrical current signal, for example utilizing closed-loop and/or open-loop control. For example, the differential pressure is determined by virtue of the fluid pressure in the region 76 positioned upstream being measured and the fluid pressure in the region 78 positioned downstream being estimated.

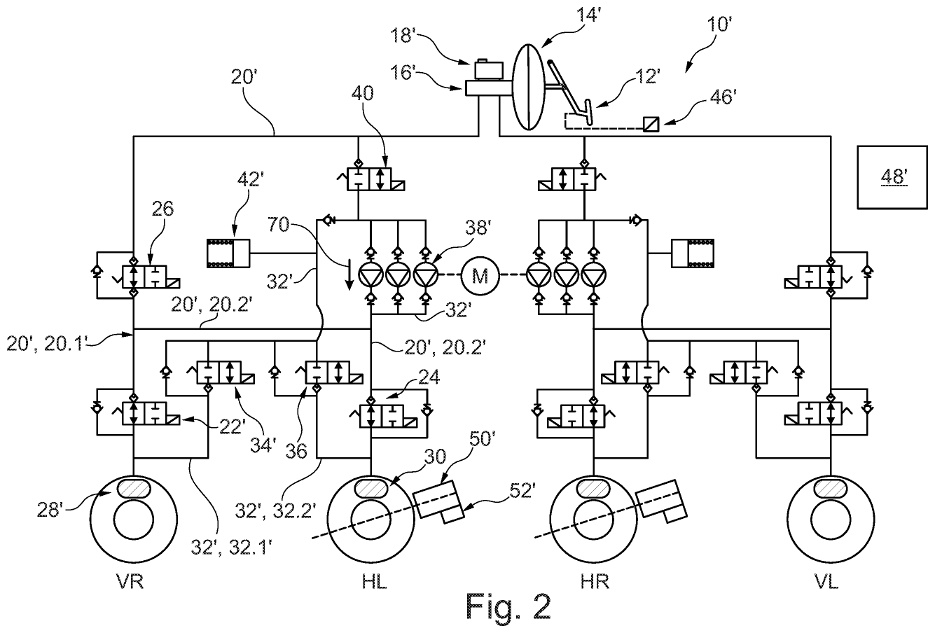

FIG. 2 shows a further possible embodiment of a hydraulic brake system 10′ which is suitable for performing a regenerative braking process and which may be used for example in a motor vehicle. In the hydraulic brake system 10′, two hydraulically mutually separate brake circuits are provided. There are preferably interactions between the two brake circuits. For example, a pressure equalization takes place via a common brake cylinder 16′, such that the same brake pressure prevails in both brake circuits. Below, only one of the brake circuits will be referred to, wherein the other brake circuit may be of identical and/or functionally identical construction. For the sake of simplicity and for better clarity, any signal lines that are present have been omitted in FIG. 2.

The hydraulic brake system 10′ of FIG. 2 is a brake system as described in WO 2014/082885 A1. In this respect, with regard to the construction and the functionality of the hydraulic brake system 10′, reference is made to the disclosure of WO 2014/082885 A1, which is hereby incorporated in its entirety into the description.

The above-described components of the hydraulic brake system 10 of FIG. 1 may likewise be present in the hydraulic brake system 10′. The hydraulic brake system 10′ comprises for example a brake pedal 12′, a brake force booster 14′, a brake cylinder 16′, a reservoir 18′, a feed line 20′, an isolation valve 22′, a wheel brake 28′, a return line 32′, a pressure dissipation valve 34′, a pump 38′, an accumulator 42′, a pedal travel sensor 46′, a control unit 48′, an electric machine 50′ and a control unit 52. These components may be structurally identical and/or functionally identical to the corresponding components of the hydraulic brake system 10 of FIG. 1.

For example, the brake pedal 12′ may correspond and/or be structurally identical and/or functionally identical to the brake pedal 12, the brake force booster 14′ may correspond and/or be structurally identical and/or functionally identical to the brake force booster 14, the brake cylinder 16′ may correspond and/or be structurally identical and/or functionally identical to the brake cylinder 16, the reservoir 18′ may correspond and/or be structurally identical and/or functionally identical to the reservoir 18, the feed line 20′ may correspond and/or be structurally identical and/or functionally identical to the feed line 20, the isolation valve 22′ may correspond and/or be structurally identical and/or functionally identical to the isolation valve 22, the wheel brake 28′ may correspond and/or be structurally identical and/or functionally identical to the wheel brake 28, the return line 32′ may correspond and/or be structurally identical and/or functionally identical to the return line 32, the pressure dissipation valve 34′ may correspond and/or be structurally identical and/or functionally identical to the pressure dissipation valve 34, the pump 38′ may correspond and/or be structurally identical and/or functionally identical to the pump 38, the accumulator 42′ may correspond and/or be structurally identical and/or functionally identical to the accumulator 42, the pedal travel sensor 46′ may correspond and/or be structurally identical and/or functionally identical to the pedal travel sensor 46, the control unit 48′ may correspond and/or be structurally identical and/or functionally identical to the control unit 48, the electric machine 50′ may correspond and/or be structurally identical and/or functionally identical to the electric machine 50, and the control unit 52′ may correspond and/or be structurally identical and/or functionally identical to the control unit 52, of the hydraulic brake system 10 of FIG. 1. In this respect, reference is made to the description relating to the hydraulic brake system 10 of FIG. 1.

FIG. 2 illustrates four vehicle wheels, which are each assigned a wheel brake. The brake circuit under consideration comprises not only the wheel brake 28′ but also a further wheel brake 30, which is assigned to a different vehicle wheel. The two vehicle wheels with the associated wheel brakes 28′ and 30 may be present at a common axle or may be assigned to different axles, for example to the front axle and to the rear axle of a motor vehicle. FIG. 2 shows, by way of example, an assignment of the vehicle wheels to the front axle and to the rear axle in a diagonal configuration, wherein VR denotes the front right vehicle wheel, VL denotes the front left vehicle wheel, HR denotes the rear right vehicle wheel, and HL denotes the rear left vehicle wheel. By way of example, in FIG. 2, the electric machine 50′ is assigned to the rear axle. The electric machine 50′ interacts with the vehicle wheel at the rear left. For example, a further electric machine may be provided which interacts with the vehicle wheel at the rear right. It is also possible for the rear axle to be assigned an electric machine which is common to both vehicle wheels.

The two wheel brakes 28′ and 30 are jointly hydraulically connected to the feed line 20′, wherein, at one end, the brake cylinder 16′ is present and, at another end, the feed line 20′ divides into two line portions 20.1′ and 20.2′, which are in each case hydraulically connected to one of the wheel brakes 28′ and 30. The line portion 20.1′ is assigned the isolation valve 22′, and the line portion 20.2′ is assigned a separate isolation valve 24. The isolation valves 22′ and 24 are preferably structurally identical and/or functionally identical with respect to one another.

The return line 32 provided in the case of the hydraulic brake system 10 of FIG. 1 at least partially corresponds to the return line 32′, which is assigned the pump 38′ and the accumulator 42′. As viewed in the direction of the wheel brakes 28′ and 30, the return line 32′ divides into two line portions 32.1′ and 32.2′, which are in each case hydraulically connected to one of the wheel brakes 28′ and 30. Aside from the pressure dissipation valve 34′, a further pressure dissipation valve 36 is provided, which are assigned in each case to one of the line portions 32.1′, 32.2′ of the return line 32′. By means of the isolation valves 22′ and 24, each of the two wheel brakes 28′ and 30 can be separately hydraulically isolated. By means of the pressure dissipation valves 34′ and 36, it is possible, separately for each of the wheel brakes 28′ and 30, for a volume fraction of a hydraulic fluid displaced by means of the brake cylinder 16 to be conducted onward in the associated line portion 32.1′, 32.2′ of the return line 32′ in order to be stored in the accumulator 42′.

Preferably, the control unit 48′ is of extended functional scope in relation to the control unit 48 of the hydraulic brake system 10 in FIG. 1 such that, aside from the isolation valve 22′ and the pressure dissipation valve 34′, which are assigned to the wheel brake 28′, it is additionally also possible for the isolation valve 24 and the pressure dissipation valve 36, which are assigned to the wheel brake 30 to be activated. The isolation valve 24 and the pressure dissipation valve 36 are preferably activatable by the control unit 48 in the same way as the isolation valve 22′ and the pressure dissipation valve 34′. For example, the isolation valves 22′, 24 and the pressure dissipation valves 34′, 36 are a constituent part of an anti-lock braking system which is provided by means of the hydraulic brake system 10′. For example, the control unit 48′ is additionally configured for executing the hydraulic brake system 10′ during an anti-lock braking process.

As regards the regenerative braking process described with reference to FIG. 1, with regard to the embodiment of FIG. 2, a distinction is to be made between the rear vehicle wheels HL, HR and the front vehicle wheels VL, VR and the respectively assigned wheel brakes, wherein, for the sake of simplicity, only the vehicle wheel VR and the vehicle wheel HL and the assigned wheel brakes 28′, 30 will be considered below.

In the case of the hydraulic brake system 10′ of FIG. 2, the functions of the hydraulic brake system 10 of FIG. 1, as have been described above, are preferably implemented at the front vehicle wheels VL, VR and the assigned wheel brakes.

The control unit 48′ is therefore preferably configured such that, in the presence or upon an onset of an actuation of the brake cylinder 16′ and in particular in the presence or upon an onset of a generator braking torque originating from the electric machine 50′, the control unit activates the pressure dissipation valve 34′ for adjustment in a direction away from a closed state, in particular for adjustment in the direction of an open position. Preferably, the pressure dissipation valve 34′ is activated for adjustment in a direction away from the closed state in order to conduct at least a volume fraction of a hydraulic fluid displaced by means of the actuation of the brake cylinder 16′ into the accumulator 42′.

The control unit 48′ is preferably configured such that, after the adjustment of the pressure dissipation valve 34′ away from the closed state, the control unit activates the pressure dissipation valve 34′ for resetting in the direction of the closed state, in particular into the closed state, in order to realize an increase of the hydraulic braking torque effected by the wheel brake 28′, for example proceeding from a value of zero or some other torque value. Such a situation may exist if the overall braking torque, that is to say the sum of the hydraulic braking torque and of the generator braking torque, is lower than the braking torque demand input by means of the displacement of the hydraulic fluid. By means of the adjustment of the pressure dissipation valve in the direction of the closed state or into the closed state, this gap between the overall braking torque and the braking torque demand can be closed.

The control unit 48′ is preferably configured such that, after the adjustment of the pressure dissipation valve 34′ in the direction of the closed state or into the closed state, the control unit activates the pump 38′ to impart a conveying action in order to convey at least a volume fraction of the hydraulic fluid stored in the accumulator 42′ in the direction of the wheel brake 28′ and thus realize an increase of the hydraulic braking torque effected by the wheel brake 28′. Such a situation may exist if, despite the adjustment of the pressure dissipation valve 34′ in the direction of the closed state or into the closed state, the overall braking torque is still lower than the braking torque demand and, for example, the overall braking torque is higher than the torque limit of the electric machine 50′.

The control unit 48′ is preferably configured such that, in the presence of an actuation of the brake cylinder 16′ and in particular in the presence or upon the onset of a generator braking torque originating from the electric machine 50′, the control unit activates the isolation valve 22′ for adjustment in the direction of a closed state in order, by means of the isolation valve 22′, to set a pressure difference between the region positioned upstream and the region positioned downstream. The control unit 48′ is preferably configured to determine the pressure difference from measured values and estimated values, wherein the measured values relate to a fluid pressure in the region positioned upstream and the estimated values relates to a fluid pressure in the region positioned downstream.

The control unit 48′ is preferably configured to perform the activation of the isolation valve 22′ for adjustment in the direction of the closed state such that the hydraulic braking torque effected by the wheel brake 28′ is set. In particular, the activation of the isolation valve 22′ for adjustment in the direction of the closed state is to be performed such that the increase of the fluid pressure in the wheel brake 28′ and thus the increase of the hydraulic braking torque effected by the wheel brake 28′ are metered. The control unit 48′ is preferably furthermore configured such that the activation of the isolation valve 22′ for adjustment in the direction of the closed state is performed such that a reaction force which acts on the actuated brake pedal 12′ is set.

The control unit 48′ is preferably configured such that, after the adjustment of the pressure dissipation valve 34′ in the direction of the closed state, the control unit activates the pressure dissipation valve 34′ for adjustment in the direction away from the dosed state in order to conduct at least a volume fraction of the hydraulic fluid into the accumulator 42′ again, and the control unit furthermore activates the isolation valve 22′ for adjustment in the direction of a dosed state in order to at least partially hydraulically isolate the wheel brake 28′ from the brake cylinder 16′ and/or from the accumulator 42′. For example, the control unit 48′ is configured such that, after the adjustment of the pressure dissipation valve 34′ in the direction of the dosed state, the control unit activates the pressure dissipation valve 34′ for adjustment in the direction away from the dosed state and subsequently or simultaneously activates the isolation valve 22′ for adjustment in the direction of the dosed state.

The pressure dissipation valve 36, which is assigned to the wheel brake 30 at the rear vehicle wheel HL, preferably remains in a dosed state. Preferably, the isolation valve 24 is activated by the control unit 48′ for adjustment in the direction of a dosed state, in particular for adjustment into the dosed state, in order to at least partially or entirely hydraulically isolate the wheel brake 30 from the brake cylinder 16′. In this way, the hydraulic braking torque provided during the generator braking process in the above-described braking phases is generated primarily or exclusively by the front wheel brakes, which are thus assigned to the front vehicle wheels VR, VL. It is basically self-evidently also possible for the wheel brakes of the rear vehicle wheels HR, HL to effect the hydraulic braking torque or at least a fraction of the hydraulic braking torque. The respectively associated isolation valve and/or pressure dissipation valve must then be correspondingly adjusted, for example in accordance with the method implementation at the wheel brakes of the front vehicle wheels VR, VL.

As can also be seen from FIG. 2, the feed line 20′ may be assigned a further isolation valve 26, which is arranged in the feed line between the division into the line portions 20.1′, 20.1′ and the brake cylinder 16. Furthermore, a supply valve 40 may be assigned to the return line 32′. By means of the supply valve 40, the return line 32′ can be hydraulically connected, bypassing the further isolation valve 26, to a region positioned upstream of the isolation valve 26. For example, the isolation valve 26 and the supply valve 40 are a constituent part of a driving dynamics control system (ESP). For example, the control unit 48′ is additionally configured for executing the hydraulic brake system 10′ during a driving dynamics control process.

In the embodiment of FIG. 2, the isolation valve 22′ can be utilized for setting the hydraulic braking torque effected by the wheel brake 28′, and the further isolation valve 26 can be utilized for realizing the above-described pedal force simulator. In this case, the control unit 48′ is configured such that, in the presence of an actuation of the brake cylinder 16′ and in particular in the presence or upon the onset of a generator braking torque originating from the electric machine 50′, the control unit activates the further isolation valve 26 for adjustment in the direction of a closed state in order, by means of the further isolation valve 26, to set a pressure difference between the region positioned upstream of the further isolation valve 26 and the region positioned downstream of the further isolation valve 26 and thus set the reaction force which acts on the actuated brake pedal 12′.

In the present description, the reference to a particular aspect or a particular embodiment or a particular refinement means that a particular feature or a particular characteristic described in conjunction with the respective aspect or the respective embodiment or the respective refinement is comprised at least therein but need not necessarily be comprised in all aspects or embodiments or refinements of the present disclosure. It is expressly pointed out that any combination of the various features and/or structures and/or characteristics described with regard to the present disclosure are encompassed by the present disclosure unless this is expressly or positively ruled out by the context.

The use of individual or all examples or of an exemplary phrasing in the text is intended merely to illustrate the present disclosure and does not constitute a limitation with regard to the scope of the present disclosure, unless stated otherwise. Also, no phrasing or wording of the description is to be understood as referring to an element which is not claimed but which is essential for the practical implantation of the present disclosure.

What is claimed is:

1. A method for controlling a hydraulic brake system during a regenerative braking process, wherein a displacement of a hydraulic fluid in the direction of a wheel brake is performed by means of a brake cylinder, wherein the method comprises the step whereby an isolation valve which is assigned in terms of flow to the wheel brake and which is situated in a flow path of the hydraulic fluid is adjusted in the direction of a closed state in order to set a pressure difference between a region positioned upstream of the isolation valve in terms of flow and a region positioned downstream of the isolation valve in terms of flow.

2. The method as defined in claim 1, wherein the isolation valve is adjusted in the direction of the closed state such that a hydraulic braking torque effected by the wheel brake is set.

3. The method as defined in claim 1, wherein the isolation valve is adjusted in the direction of the closed state such that a reaction force which acts on an actuated brake pedal or on some other actuating device which actuates the brake cylinder is set.

4. The method as defined in claim 1, wherein the isolation valve is adjusted in the direction of the closed state such that, firstly, a hydraulic braking torque effected by the wheel brake is set and, secondly, a reaction force which acts on an actuated brake pedal or on some other actuating device which actuates the brake cylinder is set.

5. The method as defined in claim 1, wherein the isolation valve performs a back-and-forth movement between a closed position and an open position in order to set the pressure difference.

6. The method as defined in claim 1, wherein the isolation valve is actuated by means of an associated actuator, in order to set the pressure difference, by virtue of the actuator being activated by means of an electrical voltage signal and/or electrical current signal, for example utilizing closed-loop and/or open-loop control.

7. The method as defined in claim 6, wherein the actuator is activated by means of a pulse-width-modulated electrical signal.

8. The method as defined in claim 7, wherein the pressure difference is determined by virtue of a first fluid pressure present in the region positioned upstream being measured and a second fluid pressure present in the region positioned downstream being estimated.

9. The method as defined in claim 8, wherein a pressure dissipation valve which is positioned between the isolation valve and the wheel brake in terms of flow is situated in an open position, or is adjusted in the direction of an open position, in order to conduct at least a volume fraction of the hydraulic fluid into an accumulator.

10. The method as defined in claim 9, wherein a pressure dissipation valve which is positioned between the isolation valve and the wheel brake in terms of flow is situated in a closed state, or is adjusted in the direction of a closed state, in order to keep an accumulator for the hydraulic fluid hydraulically separate, or to at least partially hydraulically separate the accumulator, from the wheel brake.

11. The method as defined in claim 10, wherein, by means of a pump, at least one volume fraction of the hydraulic fluid is conveyed out of the accumulator in order to set the pressure difference between the upstream region and the downstream region.

12. A hydraulic brake system for a motor vehicle, comprising:
a brake cylinder and a wheel brake which are hydraulically connected to one another via a feed line, wherein the brake cylinder is configured to displace a hydraulic fluid in the direction of the wheel brake, and the wheel brake is configured to impart a hydraulic braking torque by means of the hydraulic fluid;
an isolation valve which is fluidically assigned to the feed line and which is configured to close the feed line;
a return line for returning at least a volume fraction of the hydraulic fluid from a region positioned downstream of the isolation valve into a region positioned upstream of the isolation valve;
a pressure dissipation valve, a pump and an accumulator, which are fluidically assigned to the return line, wherein the pump is configured to convey at least a volume fraction of the hydraulic fluid, the accumulator is configured to store at least a volume fraction of the hydraulic fluid, and the pressure dissipation valve is configured to open the return line;
a control unit which is connected in signal-exchanging fashion to the isolation valve, the pressure dissipation valve and the pump and which is configured such that, in the presence of an actuation of the brake cylinder and in particular in the presence of a generator braking torque of an electric machine, the control unit activates the isolation valve for adjustment in the direction of a closed state in order to set a pressure difference between the region positioned upstream and the region positioned downstream.

13. The brake system as defined in claim 12, wherein the control unit is configured to perform the activation of the isolation valve for adjustment in the direction of the closed state such that the hydraulic braking torque effected by the wheel brake is set.

14. The brake system as defined in claim 12, wherein the control unit is configured to perform the activation of the isolation valve for adjustment in the direction of the closed state such that a reaction force which acts on an actuated brake pedal or on some other actuating device which actuates the brake cylinder is set.

15. The brake system as defined in claim 12, wherein the control unit is configured to perform the activation of the isolation valve for adjustment in the direction of the closed state such that, firstly, a hydraulic braking torque effected by the wheel brake is set and, secondly, a reaction force which acts on an actuated brake pedal or on some other actuating device which actuates the brake cylinder is set.

16. The brake system as defined in claim 12, wherein the control unit is configured to perform the activation of the isolation valve such that the isolation valve performs a back-and-forth movement between a closed position and an open position in order to set the pressure difference.

17. The brake system as defined in claim 16, wherein the isolation valve is assigned an actuator which is connected in signal-exchanging fashion to the control unit and which is configured to actuate the isolation valve, and wherein the control unit is configured to activate the actuator by means of a pulse-width-modulated electrical signal, in particular an electrical voltage signal and/or an electrical current signal, for adjustment of the isolation valve in order to set the pressure difference between the region positioned upstream and the region positioned downstream.

18. The brake system as defined in claim 17, wherein the control unit is configured to determine the pressure difference on the basis of measured values relating to a first fluid pressure prevailing in the region positioned upstream and estimated values relating to a second fluid pressure prevailing in the region positioned downstream.

19. The brake system as defined in claim 18, wherein the control unit is configured to activate the pressure dissipation valve for adjustment into an open position in order to conduct at least a volume fraction of the hydraulic fluid into the accumulator.

20. The brake system as defined in claim 18, wherein the control unit is configured to activate the pump to impart a conveying action in order to convey at least a volume fraction of the hydraulic fluid out of the accumulator and thus set the pressure difference between the region positioned upstream and the region positioned downstream.
